(19) United States
(12) Patent Application Publication
(10) Pub. No.: US 2026/0164116 A1
(43) Pub. Date: Jun. 11, 2026

(54) IMAGING APPARATUS AND CONTROL METHOD THEREOF

(71) Applicant: CANON KABUSHIKI KAISHA, Tokyo (JP)

(72) Inventors: WATARU SUZUKI, Saitama (JP); SEIJI OGAWA, Tokyo (JP)

(21) Appl. No.: 19/181,909

(22) Filed: Apr. 17, 2025

(30) Foreign Application Priority Data
Apr. 25, 2024 (JP) 2024-071109

(51) Int. Cl. H04N 23/63; H04N 23/611; H04N 23/67

(52) U.S. Cl. CPC H04N 23/635; H04N 23/611; H04N 23/675

(57) ABSTRACT

An imaging apparatus according to the present invention includes a processor, and a memory storing a program which, when executed by the processor, causes the imaging apparatus to perform drawing processing of drawing a display object, perform superimposition processing of superimposing the drawn display object on a captured image, and perform control processing of controlling to display, on a display, a captured image on which the display object is superimposed, wherein in the drawing processing, in a case where a predetermined condition is not satisfied, the display object is drawn at a predetermined size, and in a case where the predetermined condition is satisfied, the display object is drawn at a size smaller than the predetermined size.

### BACKGROUND OF THE INVENTION

### Field of the Invention

The present invention relates to an imaging apparatus and a control method thereof.

### Description of the Related Art

As a function of a digital camera, a live view display function of displaying on a display device in real time an image (captured image) obtained by an imaging element is known. Performance of object detection and performance of object tracking have been improved due to improvement in performance of a digital camera, and it is required to display not only a live view image but also a display object superimposed on the live view image at a high frame rate. The number of display objects displayed at a time is also increasing due to an increase in resolution of a back display of a digital camera or an electric view finder (EVF), an increase in functionality of the digital camera, and the like. Therefore, it has become difficult to display a display object at a high frame rate.

WO 2017/061434 A discloses a technique for converting a coordinate system of high-resolution graphic data into a coordinate system of low-resolution graphic data and outputting the graphic data at a low resolution on the basis of the low-resolution coordinate system.

JP 2016-063537 A discloses a technique for suppressing latency caused by data transmission in image shooting and display. In the technique disclosed in JP 2016-063537 A, a partial region of a shot image is transmitted as an image having the highest resolution, another region is transmitted as an image reduced by ¼ times, and an entire region is transmitted as an image reduced by 1/16 times, in a stream format for each row in a configuration of a virtual composite image. The area of the composite image is determined based on the transmission bandwidth and the frame rate.

In the technique disclosed in WO 2017/061434 A, graphic data is output at a low resolution, so that graphic data can be output at a high frame rate. However, due to the lowering of resolution, visibility of graphic data is reduced. In the technique disclosed in JP 2016-063537 A, an image transmitted at a low resolution is not a display object but a shot image. Therefore, even if the technology disclosed in JP 2016-063537 A is used, the display object cannot be displayed at a high frame rate.

### SUMMARY OF THE INVENTION

The present invention enables display of a display object at a high frame rate while suppressing a reduction in visibility of the display object superimposed on an imaging apparatus.

An imaging apparatus according to the present invention includes a processor, and a memory storing a program which, when executed by the processor, causes the imaging apparatus to perform drawing processing of drawing a display object, perform superimposition processing of superimposing the drawn display object on a captured image, and perform control processing of controlling to display, on a display, a captured image on which the display object is superimposed, wherein in the drawing processing, in a case where a predetermined condition is not satisfied, the display object is drawn at a predetermined size, and in a case where the predetermined condition is satisfied, the display object is drawn at a size smaller than the predetermined size.

Further features of the present invention will become apparent from the following description of exemplary embodiments with reference to the attached drawings.

### BRIEF DESCRIPTION OF THE DRAWINGS

FIGS. 1A and 1B are external views of a digital camera;

FIG. 2 is a block diagram of the digital camera;

FIG. 3 is a flowchart of shooting mode processing;

FIG. 4A is a schematic diagram of a menu screen;

FIG. 4B is a schematic diagram of a display frame rate setting screen;

FIG. 5A is a schematic diagram of a live view image;

FIGS. 5B to 5E are schematic diagrams of a shooting screen; and

FIG. 6 is a schematic diagram of a layered structure of an image.

### DESCRIPTION OF THE EMBODIMENTS

Embodiments of the present invention will be described. Hereinafter, an example in which the present invention is applied to a digital camera will be described.

As an example, a scene in which shooting is performed after focusing is adjusted. In such a scene, the digital camera may display a display object such as a detection frame, an autofocus (AF) frame, or an in-focus frame superimposed on a live view image (on screen display (OSD)). The detection frame is displayed to notify a user of a detected object. The AF frame is displayed to notify the user of a position or a region to be focused. The in-focus frame is displayed to notify the user of a focused position or region.

However, if the frame rate of the display object is slower than the frame rate of the live view image, correct information may not be conveyed to the user. For example, the detection frame indicates a region deviated from the detected object, or the in-focus frame indicates a region shifted from the focused region. AF processing may be performed to focus on a region different from the region indicated by the AF frame.

These deviations can be reduced by lowering the resolution of the display object and increasing the frame rate, but correct information may not be conveyed to the user due to a decrease in visibility of the display object.

Although details will be described later, in the present embodiment, by switching execution/non-execution of the lowering (reduction) of resolution of the display object, it is possible to display the display object at a high frame rate while suppressing a decrease in visibility of the display object superimposed on the imaging apparatus.

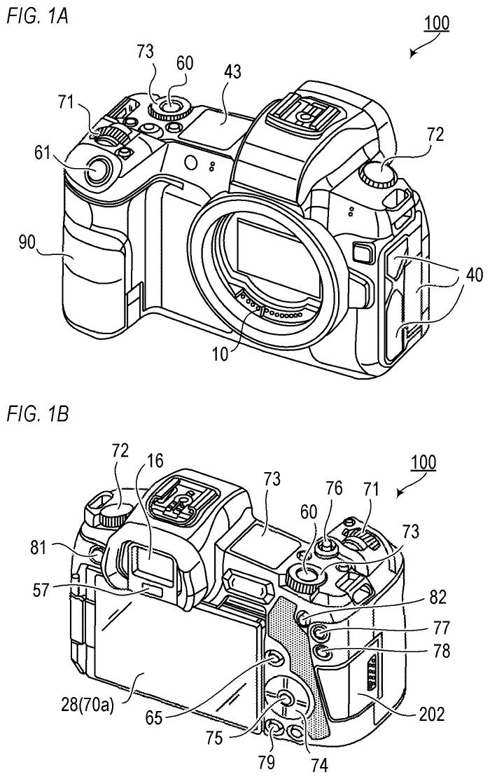

FIGS. 1A and 1B are external views of a digital camera 100 as an example of an imaging apparatus to which the present invention can be applied. FIG. 1A is a front perspective view of the digital camera 100, and FIG. 1B is a rear perspective view of the digital camera 100.

A display unit 28 is a display unit provided on the back surface of the digital camera 100 and displays an image and various types of information. A touch panel 70a can detect a touch operation on a display surface (touch operation surface) of the display unit 28. An out-of-finder display unit 43 is a display unit provided on the upper surface of the digital camera 100 and displays various setting values of the digital camera 100 including a shutter speed and an aperture. A shutter button 61 is an operation member for giving a shooting instruction. A mode selector switch 60 is an operation member for switching among various modes. A terminal cover 40 is a cover that protects a connector (not illustrated) that connects the digital camera 100 to an external device.

A main electronic dial 71 is a rotation operation member, and a setting value such as a shutter speed or an aperture can be changed by turning the main electronic dial 71. A power switch 72 is an operation member for switching between ON and OFF of a power supply of the digital camera 100. A sub-electronic dial 73 is a rotation operation member, and movement of a selection frame (cursor), image feeding, and the like can be performed by turning the sub-electronic dial 73. A four-direction key 74 is configured to be pressable at each of upper, lower, left, and right portions and processing corresponding to a pressed portion of the four-direction key 74 can be performed. A SET button 75 is a push button and is mainly used to determine a selection item. A multi-controller (hereinafter, MC) 65 can receive direction instructions in eight directions and a pushing operation of the central portion.

A movie button 76 is used for an instruction to start or stop movie shooting (recording). An AE lock button 77 is a push button, and an exposure state can be fixed by pressing the AE lock button 77 in a shooting standby state. An enlargement button 78 is an operation button for switching between ON and OFF of an enlargement mode in live view display (LV display) of a shooting mode. By turning ON the enlargement mode and then operating the main electronic dial 71, the live view image (LV image) can be enlarged or reduced. In a playback mode, the enlargement button 78 functions as an operation button for enlarging a playback image or increasing its enlargement ratio. A playback button 79 is an operation button for switching between the shooting mode and the playback mode. During the shooting mode, the mode shifts to the playback mode by pressing the playback button 79, and the latest one of images recorded in a recording medium 200 (described later) can be displayed on the display unit 28. A menu button 81 is a push button used to perform an instruction operation for displaying a menu screen, and when the menu button 81 is pressed, a menu screen on which various settings can be performed is displayed on the display unit 28. The user can perform various settings instinctively by using the menu screen displayed on the display unit 28, the four-direction key 74, and the SET button 75, or the MC65. A line-of-sight confirmation button 82 is an operation member included in an operation unit 70, and is a push button for instructing execution or release of object selection based on a position of a line-of-sight pointer to be described later. The line-of-sight confirmation button 82 is disposed at a position where the user can easily operate the line-of-sight confirmation button 82 even in a state where the user looks into the finder (a state where the user has an eye on an eyepiece portion 16), and is disposed at a position where the user can operate the line-of-sight confirmation button 82 with the thumb of the right hand holding a grip portion 90.

A communication terminal 10 is a communication terminal that causes the digital camera 100 to perform communication with a lens unit 150 (described later; detachable) side. The eyepiece portion 16 is an eyepiece portion of the eyepiece viewfinder (viewing-type finder), and the user can view a video displayed in an electric viewfinder (EVF) 29 (described later) via the eyepiece portion 16. An eyepiece detection unit 57 is an eyepiece detection sensor which detects whether an eye of the user (person who performs shooting) approaches the eyepiece portion 16. A lid 202 is a lid of a slot which stores a recording medium 200 (described later). The grip portion 90 is a holding portion which is formed into a shape in which the user can easily grip the grip portion 90 with the right hand when holding up the digital camera 100. The shutter button 61 and the main electronic dial 71 are disposed at positions where the user can operate the shutter button 61 and the main electronic dial 71 with the index finger of the right hand in a state in which the user holds the digital camera 100 while gripping the grip portion 90 with the little finger, the ring finger, and the middle finger of the right hand. Also, in the same state, the sub-electronic dial 73 and the line-of-sight confirmation button 82 are arranged at positions where the user can operate the sub-electronic dial 73 and the line-of-sight confirmation button 82 with the thumb finger of the right hand.

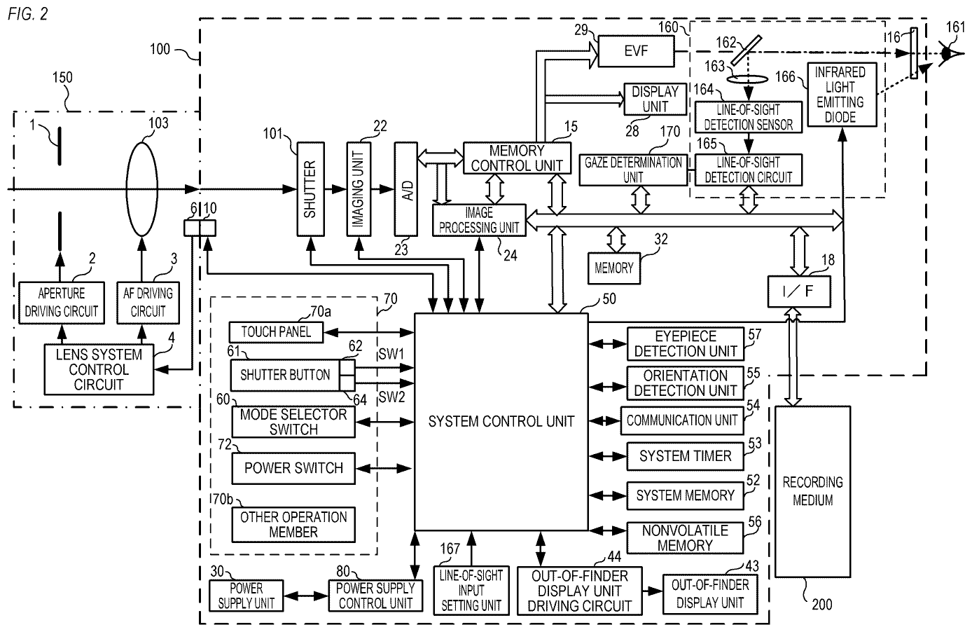

FIG. 2 is a block diagram illustrating a configuration of the digital camera 100. The lens unit 150 is a lens unit equipped with an interchangeable imaging lens. A lens 103 is usually configured with a plurality of lenses, but FIG. 2 illustrates only one lens in a simplified manner. A communication terminal 6 is a communication terminal which causes the lens unit 150 to communicate with the digital camera 100 side, and the communication terminal 10 is a communication terminal that causes the digital camera 100 to communicate with the lens unit 150 side. The lens unit 150 communicates with a system control unit 50 via the communication terminals 6 and 10. Then, the lens unit 150 controls an aperture 1 via an aperture driving circuit 2 by an internal lens system control circuit 4. Furthermore, the lens unit 150 adjusts the focus by displacing the lens 103 via an AF driving circuit 3 by the lens system control circuit 4.

A shutter 101 is a focal plane shutter which can freely control the exposure time of an imaging unit 22 under the control of the system control unit 50.

The imaging unit 22 is an imaging element (image sensor) configured with a CCD, a CMOS element, or the like which converts an optical image into an electrical signal. The imaging unit 22 may include an imaging-surface phase-difference sensor for outputting defocus amount information to the system control unit 50. An A/D converter 23 converts an analog signal output from the imaging unit 22 into a digital signal.

An image processing unit 24 performs predetermined processing (such as pixel interpolation, resizing processing such as reduction, and color conversion processing) on data from the A/D converter 23 or data from a memory control unit 15. In addition, the image processing unit 24 performs predetermined arithmetic processing by using captured image data, and the system control unit 50 performs exposure control and distance measurement control based on a calculation result obtained by the image processing unit 24. As a result, through-the-lens (TTL) type autofocus (AF) processing, auto exposure (AE) processing, flash pre-emission (EF) processing, and the like are performed. Furthermore, the image processing unit 24 performs predetermined arithmetic processing by using the captured image data and performs TTL-type auto white balance (AWB) processing based on the obtained calculation result.

The memory control unit 15 controls transmission and reception of data among the A/D converter 23, the image processing unit 24, and a memory 32. Output data from the A/D converter 23 is written into the memory 32 via the image processing unit 24 and the memory control unit 15. Alternatively, the output data from the A/D converter 23 is written into the memory 32 via the memory control unit 15 and not via the image processing unit 24. The memory 32 stores the image data which is obtained by the imaging unit 22 and is converted into digital data by the A/D converter 23 and the image data to be displayed on the display unit 28 or the EVF 29. The memory 32 has a storage capacity which is sufficient for storing a predetermined number of still images and a predetermined time of moving images and voices.

In addition, the memory 32 also serves as a memory (video memory) for image display. The image data for display written into the memory 32 is displayed by the display unit 28 or the EVF 29 via the memory control unit 15. Each of the display unit 28 and the EVF 29 performs display in accordance with a signal from the memory control unit 15, on a display such as an LCD or an organic EL. The data A/D which is converted by the A/D converter 23 and is accumulated in the memory 32 is sequentially transferred to and displayed on the display unit 28 or the EVF 29, whereby live view display (LV) can be performed. Hereinafter, an image displayed in live view display is referred to as a live view image (LV image).

A line-of-sight detection unit 160 (reception unit) detects the line of sight toward the EVF 29 from an eye of the user having the eye on the eyepiece portion 16. The line-of-sight detection unit 160 includes a dichroic mirror 162, an imaging lens 163, a line-of-sight detection sensor 164, a line-of-sight detection circuit 165, and an infrared light emitting diode 166.

The infrared light emitting diode 166 is a light emitting element for detecting a line-of-sight position of the user in a finder screen (in a display region of the EVF 29), and irradiates an eyeball (eye) 161 of the user with infrared light. Infrared light emitted from the infrared light emitting diode 166 is reflected on the eyeball (eye) 161, and the infrared reflected light reaches the dichroic mirror 162. The dichroic mirror 162 reflects only infrared light and transmits visible light. The infrared reflected light with an optical path changed forms an image on the imaging surface of the line-of-sight detection sensor 164 via the imaging lens 163. The imaging lens 163 is an optical member configuring a line-of-sight detection optical system. The line-of-sight detection sensor 164 includes an imaging device such as a CCD image sensor.

The line-of-sight detection sensor 164 photoelectrically converts the incident infrared reflected light into an electrical signal and outputs the electrical signal to the line-of-sight detection circuit 165. The line-of-sight detection circuit 165 detects a line-of-sight position of the user from a movement of the eyeball (eye) 161 of the user based on the output signal of the line-of-sight detection sensor 164, and outputs detection information to the system control unit 50.

In the present embodiment, the line-of-sight detection unit 160 detects the line of sight using a method called a corneal reflection method. The corneal reflection method is a method of detecting the direction and position of the line of sight from the positional relationship between the reflected light obtained by reflecting the infrared light emitted from the infrared light emitting diode 166 by the eyeball (eye) 161 (particularly the cornea) and the pupil of the eyeball (eye) 161. Note that a method of detecting the line of sight (the direction and position of the line of sight) is not particularly limited, and a method other than the above may be used. For example, a method called a scleral reflection method using a difference in light reflectance between the iris and the white of the eye may be used.

Various setting values of the digital camera 100 including the shutter speed and the aperture are displayed on the out-of-finder display unit 43 via an out-of-finder display unit driving circuit 44.

A nonvolatile memory 56 is an electrically erasable and recordable memory and is, for example, a flash-ROM. In the nonvolatile memory 56, constants for operations of the system control unit 50, programs, and the like are recorded. The programs as used herein are programs for executing various flowcharts described later according to the present embodiment.

The system control unit 50 is a control unit including at least one processor or circuit and controls the entire digital camera 100. The system control unit 50 implements each piece of processing of the present embodiment described later by executing programs recorded in the nonvolatile memory 56 described above. A system memory 52 is, for example, a RAM, and the system control unit 50 loads constants and variables for an operation of the system control unit 50, programs read from the nonvolatile memory 56, and the like into the system memory 52. In addition, the system control unit 50 also performs display control by controlling the memory 32, the display unit 28, and the like.

A system timer 53 is a timer unit which counts time used for various controls and time of a built-in clock.

A power supply control unit 80 includes a battery detection circuit, a DC-DC converter, a switch circuit which switches a block to be energized, and the like, and detects whether a battery is mounted, the type of battery, a remaining battery level, and the like. In addition, the power supply control unit 80 controls the DC-DC converter on the basis of a result of the detection and an instruction from the system control unit 50, and supplies a required voltage to each unit including the recording medium 200 for a necessary period of time. A power supply unit 30 includes a primary battery such as an alkaline battery or a lithium battery, a secondary battery such as a NiCd battery, a NiMH battery, or a Li battery, an AC adapter, or the like.

A recording medium I/F 18 is an interface with the recording medium 200 such as a memory card or a hard disk. The recording medium 200 is a recording medium such as a memory card for recording a captured image, and is configured with a semiconductor memory, a magnetic disk, or the like.

A communication unit 54 transmits and receives a video signal and a voice signal to and from an external device connected thereto wirelessly or via a wired cable. The communication unit 54 is also connectable to a wireless local area network (LAN) and the Internet. In addition, the communication unit 54 can communicate with an external device via Bluetooth (registered trademark) or Bluetooth Low Energy. The communication unit 54 can transmit an image shot by the imaging unit 22 (including a live view image) and an image recorded in the recording medium 200, and can receive image data and other various types of information from an external device.

An orientation detection unit 55 detects an orientation of the digital camera 100 with respect to the direction of gravity. Based on the orientation detected by the orientation detection unit 55, whether an image shot by the imaging unit 22 is an image shot with the digital camera 100 held in a horizontal position or an image shot with the digital camera 100 held in a vertical position can be determined. The system control unit 50 can add direction information corresponding to the orientation detected by the orientation detection unit 55 to an image file of the image shot by the imaging unit 22 or rotate and record the image. For example, an acceleration sensor, a gyro sensor, or the like can be used as the orientation detection unit 55. It is also possible to detect a movement of the digital camera 100 (whether the digital camera 100 is panning, tilting, lifting, stationary, or the like) by using an acceleration sensor or a gyro sensor which is the orientation detection unit 55.

The eyepiece detection unit 57 is an eyepiece detection sensor which detects approach (eye approach) and separation (eye separation) of an eye (object) 161 (approach detection) with respect to the eyepiece portion 16 of the eyepiece viewfinder (hereinafter, simply referred to as a “finder”). The system control unit 50 switches between display (display state) and non-display (non-display state) of each of the display unit 28 and the EVF 29 depending on the state detected by the eyepiece detection unit 57. More specifically, in a case of at least the shooting standby state and when the switching for a display destination is the automatic switching, the display is turned on with the display destination set as the display unit 28, and the EVF 29 is non-display during non-eye approach. In addition, during the eye approach, the display is turned on with the display destination set as the EVF 29, and the display unit 28 is non-display. For example, an infrared proximity sensor can be used as the eyepiece detection unit 57, which allows detection of the approach of any object to the eyepiece portion 16 of the finder incorporating the EVF 29. When an object approaches, infrared light emitted from a light-emitting portion (not illustrated) of the eyepiece detection unit 57 is reflected on the object and is received by a light-receiving portion (not illustrated) of an infrared proximity sensor. The distance to which the object approaches from the eyepiece portion 16 (eye approach distance) can also be determined by the amount of the received infrared light. In this way, the eyepiece detection unit 57 performs eye approach detection which detects an approach distance of the object to the eyepiece portion 16. In a case where an object which approaches within a predetermined distance of the eyepiece portion 16 is detected in the non-eye approach state (non-approach state), it is detected that the eye approaches. In a case where the object for which the approach is detected is separated from the eyepiece portion 16 by a predetermined distance or more in the eye approach state (approach state), it is detected that the eye is separated. The threshold value for detecting the eye approach and the threshold value for detecting the eye separation may be different by providing, for example, a hysteresis. After the eye approach is detected, the eye approach state is maintained until the eye separation is detected. After the eye separation is detected, the non-eye approach state is maintained until the eye approach is detected. Note that the infrared proximity sensor is an example, and other sensors may be adopted as the eyepiece detection unit 57 as long as the sensors can detect the approach of an eye or an object that can be regarded as the eye approach.

By controlling the line-of-sight detection unit 160, the system control unit 50 can detect the following states of line-of-sight to the EVF 29.
The line of sight that has not been directed to the EVF 29 is newly directed to the EVF 29. That is, the start of line-of-sight input.
A state in which the line-of-sight input to the EVF 29 is performed.
A state in which a certain position of the EVF 29 is gazed.
The line of sight directed toward the EVF 29 is removed. That is, the end of line-of-sight input.
A state in which no line-of-sight input is performed to the EVF 29 (state in which the EVF 29 is not looked at).

The system control unit 50 is notified of the operation/state and the position (direction) in which the line of sight is directed to the EVF 29 through an internal bus, and the system control unit 50 determines what kind of line-of-sight input is being performed on the basis of the notified information.

The operation unit 70 is an input unit which receives an operation from the user (user operation) and is used for inputting various operation instructions to the system control unit 50. As illustrated in FIG. 2, the operation unit 70 includes the mode selector switch 60, the shutter button 61, the power switch 72, the touch panel 70a, and the like. In addition, the operation unit 70 includes, as other operation members 70b, the main electronic dial 71, the sub-electronic dial 73, the four-direction key 74, the SET button 75, the movie button 76, the AE lock button 77, the enlargement button 78, the playback button 79, the menu button 81, the MC65, and the like.

The mode selector switch 60 switches an operation mode of the system control unit 50 to any of a still image shooting mode, a movie shooting mode, and a playback mode. The user can directly switch the operation mode to any one of these modes with the mode selector switch 60. Alternatively, the user may temporarily switch a screen to a list screen of a shooting mode with the mode selector switch 60 and then selectively switch the mode to any one of the plurality of displayed modes with another operation member. Similarly, the movie shooting mode may include a plurality of modes.

The shutter button 61 includes a first shutter switch 62 and a second shutter switch 64. The first shutter switch 62 is turned ON in the middle of an operation of the shutter button 61, that is, by so-called pressing halfway down (shooting preparation instruction), and generates a first shutter switch signal SW1. The system control unit 50 starts the shooting preparation operation such as autofocus (AF) processing, automatic exposure (AE) processing, automatic white balance (AWB) processing, or flash pre-emission (EF) processing with the first shutter switch signal SW1. The second shutter switch 64 is turned ON at completion of the operation of the shutter button 61, that is, by so-called pressing all the way down (shooting instruction), and generates a second shutter switch signal SW2. The system control unit 50 starts a series of shooting processing operations from reading a signal from the imaging unit 22 to writing a captured image as an image file into the recording medium 200, with the second shutter switch signal SW2.

The touch panel 70a and the display unit 28 can be integrally configured. For example, the touch panel 70a is configured so that a transmittance of light does not hinder display on the display unit 28, and is attached to an upper layer of the display surface of the display unit 28. Then, input coordinates on the touch panel 70a are associated with display coordinates on the display surface of the display unit 28. As a result, it is possible to provide a graphical user interface (GUI) configured as if the user can directly operate a screen displayed on the display unit 28.

The system control unit 50 can detect the following operations on the touch panel 70a or the following states of the touch panel 70a.
An operation in which a finger or a pen that has not touched the touch panel 70a newly touches the touch panel 70a, that is, a start of a touch (hereinafter, referred to as touch-down).
A state where a finger or a pen is touching the touch panel 70a (hereinafter, referred to as touch-on).
An operation in which a finger or a pen is moving while touching the touch panel 70a (hereinafter, referred to as touch-move).
An operation in which a finger or a pen that has touched the touch panel 70a is released from the touch panel 70a, that is, an end of the touch (hereinafter, referred to as touch-up).
A state in which nothing touches the touch panel 70a (hereinafter, referred to as touch-off).

When the touch-down is detected, the touch-on is detected at the same time. After the touch-down, the touch-on is continuously detected unless the touch-up is detected. Also, when the touch-move is detected, the touch-on is detected at the same time. Even when the touch-on is detected, the touch-move is not detected unless the touch position is moved. After the touch-up of all the fingers and the pens that have touched the touch panel 70a is detected, the state transitions to the touch-off.

The system control unit 50 is notified of these operations and states and position coordinates touched by a finger or a pen on the touch panel 70a via an internal bus. Then, the system control unit 50 determines what kind of operation (touch operation) has been performed on the touch panel 70a on the basis of the information of which the system control unit 50 is notified. With regard to the touch-move, a movement direction of a finger or a pen moving on the touch panel 70a can be determined for each vertical component and for each horizontal component on the touch panel 70a on the basis of a change of the position coordinates. When the touch-move for a predetermined distance or more is detected, it is determined that a sliding operation has been performed. An operation of quickly moving a finger by a certain distance while touching the touch panel 70a and releasing the finger is called a flick. In other words, the flick is an operation of quickly tracing the touch panel 70a so as to flick the touch panel 70a with a finger. When the touch-move at a predetermined speed or higher for a predetermined distance or more is detected and then the touch-up is detected, it can be determined that a flick has been performed (it can be determined that a flick has been performed following the sliding operation). Furthermore, a touch operation in which a plurality of places (for example, two points) are both touched (multi-touched) and the touch positions are brought close to each other is referred to as pinch-in, and a touch operation in which the touch positions are moved away from each other is referred to as pinch-out. The pinch-out and the pinch-in are collectively referred to as a pinch operation (or simply referred to as a pinch). The touch panel 70a may be any type of touch panel among various types such as a resistive film type, a capacitance type, a surface acoustic wave type, an infrared light type, an electromagnetic induction type, an image recognition type, and an optical sensor type. There are a type in which a touch is detected due to contact with the touch panel and a type in which a touch is detected due to approach of a finger or a pen to the touch panel, but either of these types may be used.

Note that the digital camera 100 may be provided with a voice input unit (not illustrated) which transmits, to the system control unit 50, a voice signal obtained from a built-in microphone or a voice input device connected via a voice input terminal. In this case, the system control unit 50 selects the input voice signal as necessary, performs analog-to-digital conversion, and performs level optimization processing, specific frequency reduction processing, and the like to generate a voice signal.

In the present embodiment, it is possible to set whether or not tracking is performed. When a tracking target is not designated by the user, an AF position is automatically set based on an automatic selection condition. In the case where the tracking is “performed”, if a face of a person is detected from the live view image, the face is preferentially selected as an AF target object. In the case where a plurality of faces of persons are detected, one face is selected and set as an AF target object according to the priority such as the size of the face is large, the position of the face is close to the digital camera 100 (close side), the position of the face is close to the center in the image, the face is a face of an individual registered in advance, or the like. When a face of a person is not detected, an object other than a face is selected and set as an AF target object according to priorities such as being close to the digital camera 100 (extremely close side), having high contrast, being an object with high priority including an animal and a vehicle, or being a moving body. When an object to be tracked is specified by the user, the object to be tracked is set as an AF target object.

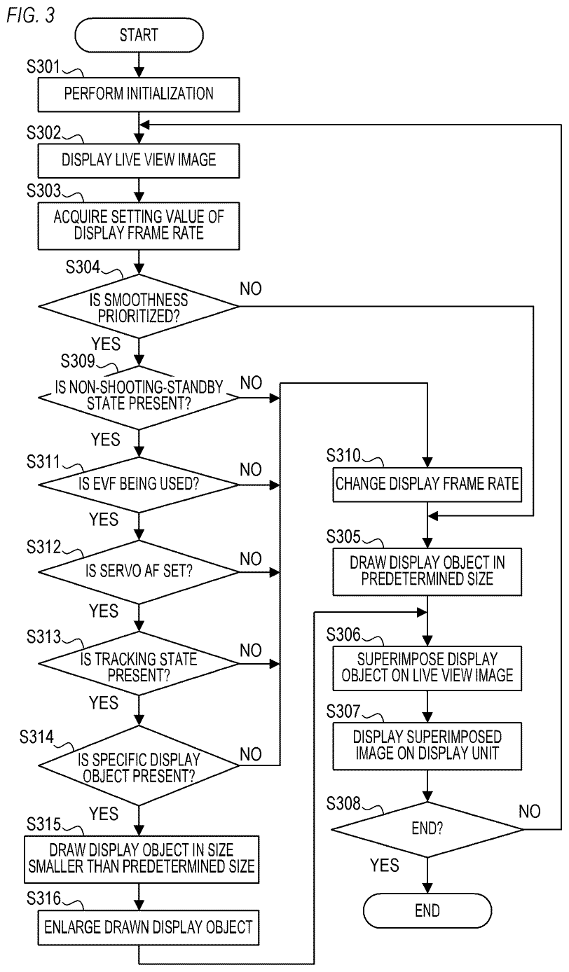

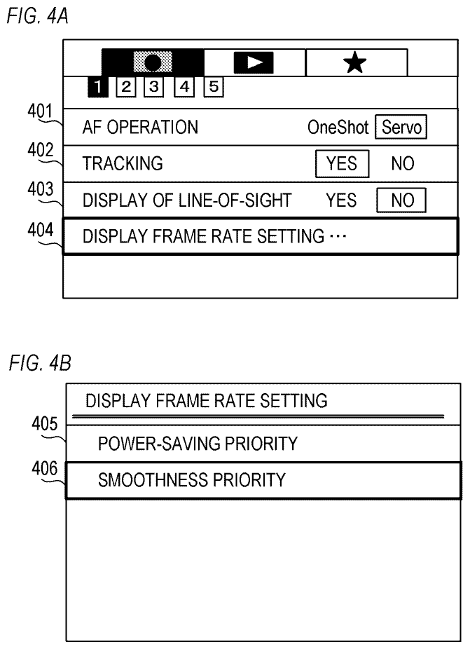

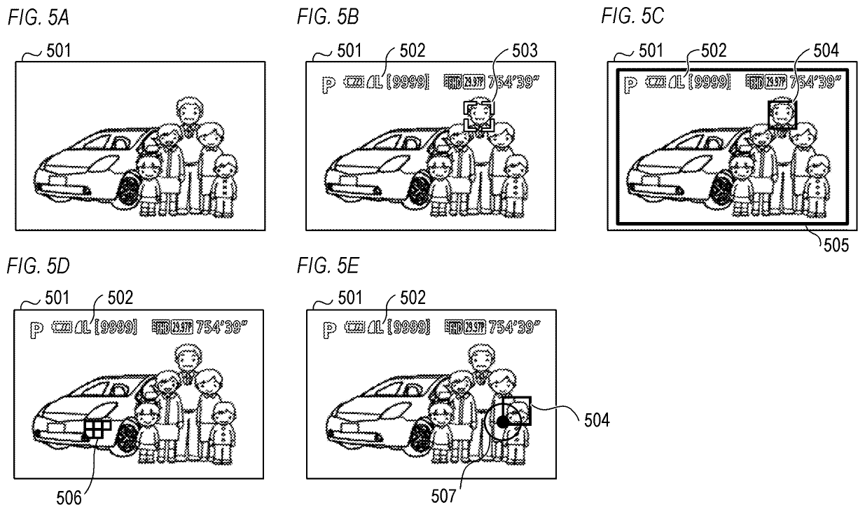

FIG. 3 is a flowchart illustrating shooting mode processing in the digital camera 100. The shooting mode processing in FIG. 3 is implemented by the system control unit 50 loading a program stored in the nonvolatile memory 56 into the system memory 52 and executing the program. For example, when a shooting mode is set, the system control unit 50 starts the shooting mode processing of FIG. 3. Note that, in FIG. 3, a plurality of operations such as a shooting preparation operation and a shooting processing operation are omitted. FIGS. 4A and 4B are schematic diagrams of a menu screen or the like for changing various settings of the digital camera 100, and FIGS. 5A to 5E are schematic diagrams of a shooting screen or the like of the digital camera 100. FIG. 3 illustrates processing related to display on the display unit 28 or the EVF 29 in the shooting mode. In the present embodiment, as described above, one of the display unit 28 and the EVF 29 is turned on and displayed depending on the eye approach detection, and the other is not displayed. Therefore, the processing of FIG. 3 is executed for the display unit 28 or the EVF 29 whose display is set to ON.

In S301, the system control unit 50 initializes a flag, a control variable, and the like.

In S302, the system control unit 50 displays the live view image (captured image) obtained using the imaging unit 22 on the display unit 28 or the EVF 29. FIG. 5A illustrates a live view image 501.

In S303, the system control unit 50 acquires the set value of the display frame rate (display mode) set using the operation unit 70. When the user selects the display frame rate setting item 404 on the menu screen illustrated in FIG. 4A, the display screen transitions from the menu screen in FIG. 4A to the display frame rate setting screen in FIG. 4B. The user can select the power-saving priority item 405 or the smoothness priority item 406 using the display frame rate setting screen. The display frame rate (display mode) of the selected item is set. The smoothness-prioritized display frame rate (display frame rate) is higher than the power-saving prioritized display frame rate. In the present embodiment, the display frame rate in the case where the smoothness priority item 406 is set is 100 fps, and the display frame rate in the case where the power-saving priority item 405 is set is 50 fps.

In S304, the system control unit 50 determines, depending on the setting value acquired in S303, whether or not the smoothness is prioritized for the set display frame rate (display mode). When the smoothness is prioritized, the process proceeds to S309, and otherwise, the process proceeds to S305.

Note that the number of display modes (display frame rates) that can be set is not particularly limited, and may be more than two. Instead of the display mode, a numerical value of the display frame rate such as 50 fps or 100 fps may be input and set. In this case, in S304, it may be determined whether or not the set display frame rate is equal to or higher than the threshold value. Then, in the case where the display frame rate is equal to or greater than the threshold value, the process may proceed to S309, and otherwise, the process may proceed to S305.

In S305, the system control unit 50 draws the display object with a predetermined size in the memory 32 or the system memory 52. The system control unit 50 sets a drawing buffer in the memory 32 or the system memory 52 at a size of a predetermined magnification of the resolution of the display unit (the display unit 28 or the EVF 29). In the present embodiment, the drawing buffer is set to have a size that is one time the resolution of the display unit, that is, the same size. Then, the display object is drawn in the set drawing buffer. In the present embodiment, the display unit 28 has a resolution of 1080×720, and the EVF 29 has a resolution of 2560×1920. Therefore, when performing display on the display unit 28, the system control unit 50 sets the drawing buffer to a size of 1080×720 corresponding to the resolution of the display unit 28 and draws the display object in the drawing buffer. When performing display on the EVF 29, the system control unit 50 sets the drawing buffer to a size of 2560×1920 corresponding to the resolution of the display unit 28 and draws the display object in the drawing buffer.

In S306, the system control unit 50 superimposes the display object drawn in the drawing buffer on the live view image. FIG. 5B illustrates a shooting screen in the shooting standby state in which a signal from the shutter button 61 is not detected. In FIG. 5B, as display objects, a shooting information icon 502 and a detection frame 503 are superimposed on the live view image 501. The shooting information icon 502 indicates various setting values related to the shooting processing. The detection frame 503 is a frame displayed at a position where a main object is detected from the live view image 501.

In S307, the system control unit 50 displays, on the display unit 28 or the EVF 29, the shooting screen (live view image on which the display object is superimposed) obtained in S306.

In S308, the system control unit 50 determines whether or not an end of the shooting mode processing has been instructed. When it is determined that the end of the shooting mode processing is instructed, the shooting mode processing is ended, and otherwise, the process proceeds to S302. For example, in the case where the mode selector switch 60 is operated, that is, in the case where switching to another operation mode is instructed, the system control unit 50 determines that the end of the shooting mode processing has been instructed. In addition, in the case where the power switch 72 is operated, that is, in the case where it is instructed to turn off the power supply of the digital camera 100, the system control unit 50 determines that the end of the shooting mode processing is instructed.

In S309, the system control unit 50 determines whether the digital camera 100 is in a state of focusing, shooting, recording, or the like (non-shooting-standby state). The process proceeds to S310 in the non-shooting-standby state, and the process proceeds to S311 otherwise (in the shooting standby state).

For example, the system control unit 50 determines that focusing is being performed when detecting the first shutter switch signal SW1 from the shutter button 61, and determines that shooting is being performed when detecting the second shutter switch signal SW2. Furthermore, when detecting that the movie button 76 has been pressed, the system control unit 50 determines that recording is being performed until the movie button 76 is pressed again.

FIG. 5C illustrates a shooting screen in a state where the first shutter switch signal SW1 and the second shutter switch signal SW2 are detected (during focusing and shooting). When detecting the first shutter switch signal SW1, the system control unit 50 performs the AF processing so as to focus on the position of the detection frame 503 in FIG. 5B, and switches the detection frame 503 to an in-focus frame 504. Then, the system control unit 50 detects the second shutter switch signal SW2, performs shooting processing, and displays a shutter frame 505 along the edge of the shooting screen for a predetermined time. The user can also perform continuous shooting of still images by continuously pressing the shutter button 61. In this case, the system control unit 50 controls the display of the shutter frame 505 using the system timer 53 such that the display and non-display of the shutter frame 505 are repeated at a predetermined cycle. The in-focus frame 504 and the shutter frame 505 are types of display objects, are drawn in the drawing buffer in S305 or S315 described later, and are superimposed on the live view image in S306.

In S310, the system control unit 50 changes (reduces) the display frame rate. For example, the system control unit 50 performs a power-saving priority processing even when the smoothness priority is set. Note that the method of changing the display frame rate is not limited thereto, and for example, drawing commands notified at a predetermined frequency may be reduced at a constant rate.

In S311, the system control unit 50 determines whether the EVF 29 is used (whether the shooting screen is displayed on the EVF 29). When the EVF 29 is used, the process proceeds to S312, and otherwise, the process proceeds to S310. Note that, in S311, it may be determined whether or not a display unit having the highest resolution is used, or it may be determined whether or not a display unit having a resolution equal to or higher than a threshold value is used. Therefore, the determination target is not limited to a rear display or an EVF, but may be an externally connected monitor. Then, when the display unit having the highest resolution or the display unit having the resolution equal to or greater than the threshold value is used, the process may proceed to S312, and otherwise, the process may proceed to S310.

In S312, the system control unit 50 determines whether or not the AF operation for keeping focusing on a moving object is set. The user can select the one-shot AF or the servo AF as an AF operation by selecting the item 401 of the AF operation on the menu screen illustrated in FIG. 4A (the AF operation can be switched between the one-shot AF and the servo AF). The one-shot AF is an AF operation for fixing focus on a stationary object, and the servo AF is an AF operation for keeping focus on a moving object. In S312, the system control unit 50 determines whether or not the servo AF is set. When the servo AF is set, the process proceeds to S313, and otherwise, the process proceeds to S310.

For example, the user selects the one-shot AF when shooting a stationary object, and selects the servo AF when shooting a moving object (or a movable object). In the case where the one-shot AF is set, focusing is maintained at the distance of the initially detected object while the shutter button 61 is pressed halfway down. In the case where the servo AF is set, the operation is performed so that the object is always focused depending on the detected position and distance of the object while the shutter button 61 is pressed halfway down.

In S313, the system control unit 50 determines whether or not the object is in a tracking state of being detected from the live view image and being tracked. In the case of the tracking state, the process proceeds to S314, and otherwise, the process proceeds to S310.

The user can select whether or not to perform tracking by selecting a tracking item 402 on the menu screen illustrated in FIG. 4A. In the case where it is set not to perform tracking, the system control unit 50 determines that it is not in the tracking state. In the case where it is set to perform the tracking, the system control unit 50 determines that it is in the tracking state if a specific object to be tracked is detected, and determines that it is not in the tracking state if the specific object is not detected.

Note that, in S313, it may be determined only whether it is set to perform the tracking. Then, in the case where it is set to perform the tracking, the process may proceed to S314, and otherwise, the process may proceed to S310.

FIG. 5D illustrates the shooting screen in the non-tracking state in which the first shutter switch signal SW1 from the shutter button 61 is detected. When detecting the first shutter switch signal SW1, the system control unit 50 performs the AF processing and displays the multipoint frame 506 (a plurality of frames having the same shape are disposed in a tile shape) in the focused region. In the case of the tracking state, a frame (the detection frame 503 in FIG. 5B or the in-focus frame 504 in FIG. 5C) surrounding the specific object to be tracked is displayed. These frames are types of display objects, and are drawn in the drawing buffer in S305 or S315 described later, and are superimposed on the live view image in S306.

In S314, the system control unit 50 determines whether or not to display a specific display object. When the specific display object is displayed, the process proceeds to S315, and otherwise, the process proceeds to S310. The specific display object is a display object whose display quality is not reduced (the degradation of the display quality is small) even when enlarged. For example, the display object of the vector data is a specific display object. A display object including only by a straight line in the horizontal direction or the vertical direction is a specific display object. A display object that is not a specific display object is a display object whose display quality is significantly reduced due to jaggies or the like when enlarged. For example, a display object including a curve or an oblique line is not a specific display object. A display object of raster data may not be a specific display object even if the display object includes only a straight line in the horizontal direction or the vertical direction. Even in the case of a display object of vector data, a display object including a curve or an oblique line may not be a specific display object.

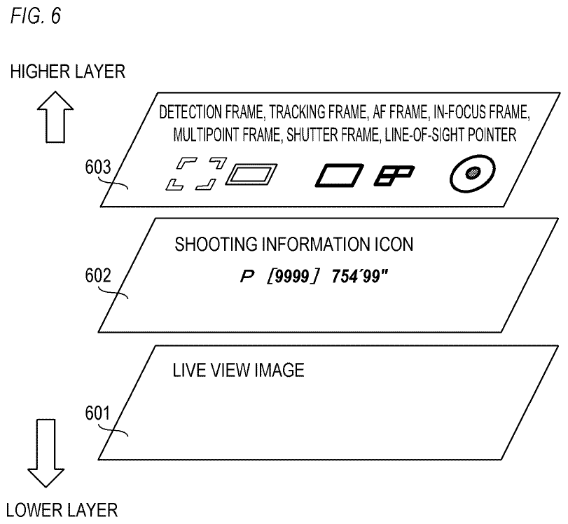

FIG. 6 is a schematic diagram illustrating a layered structure of a plurality of images including a live view image and a display object. In the present embodiment, a first drawing buffer and a second drawing buffer are prepared as drawing buffers for drawing display objects. A layer 601 is a layer of the live view image and is the lowest layer. A layer 602 is a layer of display objects drawn in the first drawing buffer. In the first drawing buffer, a shooting information icon indicating various setting values related to the shooting processing and the like are drawn. A layer 603 is a layer of display objects drawn in the second drawing buffer. In the second drawing buffer, display objects whose display positions and display/non-display change frequently, such as a detection frame, a tracking frame, an AF frame, an in-focus frame, a multipoint frame, a shutter frame, and a line-of-sight pointer, are drawn.

The user can select whether or not to display the line-of-sight pointer by selecting an item 403 of the line-of-sight pointer display on the menu screen illustrated in FIG. 4A. When it is set not to display the line-of-sight pointer, the system control unit 50 does not display the line-of-sight pointer. In the case where it is set to display the line-of-sight pointer, the system control unit 50 displays the line-of-sight pointer if the line-of-sight position of the user is detected in the eye approach state, and does not display the line-of-sight pointer otherwise.

FIG. 5E illustrates a shooting screen in a state where the line-of-sight pointer is set to be displayed and the first shutter switch signal SW1 from the shutter button 61 is detected. The system control unit 50 displays a line-of-sight pointer 507 at the detected line-of-sight position of the user. Then, when detecting the first shutter switch signal SW1, the system control unit 50 performs the AF processing so as to focus on an object displayed near the line-of-sight pointer 507, and displays the in-focus frame 504 surrounding the object. The line-of-sight pointer 507 is assumed to be a display object of raster data including a curve. Therefore, when the line-of-sight pointer 507 is to be displayed, the process proceeds to S310. Then, the line-of-sight pointer 507 is drawn in the drawing buffer in S305 and superimposed on the live view image in S306.

In S315, the system control unit 50 draws the display object with a size smaller than the predetermined size in the memory 32 or the system memory 52. The system control unit 50 sets a drawing buffer in the memory 32 or the system memory 52, and draws a display object in the set drawing buffer. In the present embodiment, with respect to the first drawing buffer, the system control unit 50 sets the drawing buffer with a size of magnification one time the resolution of the display unit to be displayed, that is, the EVF 29, and draws the display object. On the other hand, for the second drawing buffer, the drawing buffer is set to a size ½ times the resolution of the EVF 29 to draw the display object. Since the second drawing buffer is set to have a size smaller than the size of the drawing buffer set in S305, the system control unit 50 draws the display object in the second drawing buffer at a size smaller than S305, in S315. Note that the number of drawing buffers for drawing the display object is not particularly limited, and may be one or three or more. The magnification of the size of the drawing buffer with respect to the display resolution is also not particularly limited.

In S316, the system control unit 50 enlarges the display object drawn in S315 to a predetermined size (a size corresponding to the size of the resolution of the EVF 29 to be displayed). In the present embodiment, the display object in the first drawing buffer is not enlarged, but the display object in the second drawing buffer is doubled. Note that the enlargement algorithm is not particularly limited, and for example, a nearest neighbor interpolation method, a linear interpolation method, or the like is used.

Note that, although the example in which the predetermined condition for displaying the display object in a small size includes a plurality of conditions (6 conditions of S304, S309, and S311 to S314) has been described, the number of conditions may be more or less than six, or may be one. The order of the plurality of determinations corresponding to the plurality of conditions is also not particularly limited. The predetermined condition may include a condition that the acceleration of the digital camera 100 detected by the orientation detection unit 55 is equal to or greater than a threshold value. For example, in between S314 and S315, the system control unit 50 may determine whether or not the acceleration of the digital camera 100 is equal to or greater than a threshold value. Then, in the case where the acceleration is equal to or greater than a threshold value, the process may proceed to S315, and otherwise, the process may proceed to S310.

When at least one of the plurality of conditions is not satisfied, the display object is drawn in a predetermined size, and when all of the plurality of conditions are satisfied, the display object is drawn in a size smaller than the predetermined size. However, the present embodiment is not limited to this. For example, the display object may be drawn in a predetermined size when all of the plurality of conditions are not satisfied, and the display object may be drawn in a size smaller than the predetermined size when at least one of the plurality of conditions is satisfied. When the predetermined number or more of conditions are satisfied, the display object may be drawn in a size smaller than the predetermined size, and otherwise, the display object may be drawn in the predetermined size.

As described above, according to the present embodiment, the display object is drawn with the predetermined size when the predetermined condition is not satisfied, and the display object is drawn with the size smaller than the predetermined size when the predetermined condition is satisfied. By drawing the display object in the predetermined size, it is possible to suppress a reduction in visibility of the display object. Then, by drawing the display object with a size smaller than the predetermined size, the display object can be displayed at a high frame rate. As described above, according to the present embodiment, it is possible to display the display object at a high frame rate while suppressing a reduction in visibility of the display object superimposed on the imaging apparatus.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

Furthermore, in the above-described embodiment, a case where the present invention is applied to a digital camera is described as an example, but the present embodiment is not limited to this example and is also applicable to other imaging apparatuses such as a smartphone and a tablet terminal.

According to the present invention, it is possible to display a display object at a high frame rate while suppressing a reduction in visibility of the display object superimposed on an imaging apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-071109, filed on Apr. 25, 2024, which is hereby incorporated by reference herein in its entirety.

What is claimed is:

1. An imaging apparatus comprising:
a processor; and
a memory storing a program which, when executed by the processor, causes the imaging apparatus to:
perform drawing processing of drawing a display object;
perform superimposition processing of superimposing the drawn display object on a captured image; and
perform control processing of controlling to display, on a display, a captured image on which the display object is superimposed, wherein
in the drawing processing,
in a case where a predetermined condition is not satisfied, the display object is drawn at a predetermined size, and
in a case where the predetermined condition is satisfied, the display object is drawn at a size smaller than the predetermined size.

2. The imaging apparatus according to claim 1, wherein
in the superimposition processing, in a case where the predetermined condition is satisfied, the drawn display object is enlarged to the predetermined size and is superimposed on the captured image.

3. The imaging apparatus according to claim 1, wherein
any one of a plurality of display modes including a first mode and a second mode in which a display frame rate is higher than a display frame rate in the first mode is settable, and
the predetermined condition includes a condition that the second mode is set.

4. The imaging apparatus according to claim 1, wherein
the predetermined condition includes a condition that a display frame rate is equal to or higher than a threshold value.

5. The imaging apparatus according to claim 1, wherein
the predetermined condition includes a condition that an electric view finder (EVF) is used.

6. The imaging apparatus according to claim 1, wherein
the predetermined condition includes a condition that a display whose resolution is equal to or higher than a threshold value is used.

7. The imaging apparatus according to claim 1, wherein
the predetermined condition includes a condition that focusing, shooting, or recording is being performed.

8. The imaging apparatus according to claim 1, wherein
the predetermined condition includes a condition that an AF operation for keeping focusing on a moving object is set.

9. The imaging apparatus according to claim 1, wherein
the predetermined condition includes a condition that an object is in a tracking state of being detected and tracked.

10. The imaging apparatus according to claim 1, wherein
the program, when executed by the processor, further causes an electronic device to perform detection processing of detecting acceleration of the imaging apparatus, and
the predetermined condition includes a condition that the acceleration is equal to or greater than a threshold value.

11. The imaging apparatus according to claim 1, wherein
the predetermined condition includes a condition that the display object includes only a straight line in a horizontal direction or a vertical direction.

12. The imaging apparatus according to claim 1, wherein
the predetermined condition includes a plurality of conditions, and
in the drawing processing,
in a case where at least one of the plurality of conditions is not satisfied, the display object is drawn at the predetermined size, and
in a case where all of the plurality of conditions are satisfied, the display object is drawn at a size smaller than the predetermined size.

13. A control method of an imaging apparatus, comprising:
drawing a display object;
superimposing the drawn display object on a captured image; and
controlling to display, on a display, a captured image on which the display object is superimposed, wherein
in a case where a predetermined condition is not satisfied, the display object is drawn at a predetermined size, and
in a case where the predetermined condition is satisfied, the display object is drawn at a size smaller than the predetermined size.

14. A non-transitory computer readable medium that stores a program, wherein the program causes a computer to execute a control method of an imaging apparatus, the control method comprising:
drawing a display object;
superimposing the drawn display object on a captured image; and
controlling to display, on a display, a captured image on which the display object is superimposed, wherein
in a case where a predetermined condition is not satisfied, the display object is drawn at a predetermined size, and
in a case where the predetermined condition is satisfied, the display object is drawn at a size smaller than the predetermined size.
